(19) United States
(12) Patent Application Publication
(10) Pub. No.: US 2010/0153711 A1
(43) Pub. Date: Jun. 17, 2010

(54) DOWNLOADABLE CONDITIONAL ACCESS SYSTEM EFFICIENTLY DETECTING DUPLICATED DCAS HOST

(75) Inventors: Han Seung KOO, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/607,235

(22) Filed: Oct. 28, 2009

(30) Foreign Application Priority Data
Dec. 11, 2008 (KR) 10-2008-0125823
Apr. 8, 2009 (KR) 10-2009-0030247

(51) Int. Cl. H04L 29/06

(52) U.S. Cl. 713/156; 713/155

(57) ABSTRACT

A technology that may efficiently detect a duplicated Downloadable Conditional Access System (DCAS) host in a DCAS is provided.

### CROSS-REFERENCE TO RELATED APPLICATION

This application claims priority from Korean Patent Application No. 10-2008-0125823, filed on Dec. 11, 2008, and Korean Patent Application No. 10-2009-0030247, filed on Apr. 8, 2009 in the Korean Intellectual Property Office, the entire disclosure of which is incorporated herein by reference.

### BACKGROUND OF THE INVENTION

1. Field of the Invention

The present invention relates to a technology that may efficiently detect an illegally duplicated Downloadable Conditional Access System (DCAS) host in a DCAS.

2. Description of Related Art

A Downloadable Conditional Access System (DCAS) may enable a cable subscriber to purchase, at a retail store, a Set Top Box (STB) without regard to a subscribed Multiple System Operator (MSO) the cable subscriber subscribes to. Also, even when the cable subscriber changes an MSO, a DCAS may enable the cable subscriber to be continuously provided with a fee-based cable service without replacing an STB.

The above-described DCAS is to enable an MSO to securely download images of application programs requiring a security system to a Secure Micro (SM) which is a security chip of an STB. For example, the application programs may include a CAS application, a Digital Right Management (DRM) application, and an Authorized Service Domain (ASD) application. Also, the DCAS is to enable the MSO, while on-line, to install and replace the CA application, the DRM application, and the ASD applications.

### SUMMARY OF THE INVENTION

According to an aspect of the present invention, there is provided a Downloadable Conditional Access System (DCAS), including: a Conditional Access (CA) server; and a Multiple System Operator (MSO) server to store a Secure Micro (SM) identifier (ID), and when a subscription application is received from a DCAS host, to transmit a registration request for the SM ID, an operator ID, and One Time Password (OTP) data of the DCAS host to the CA server. The CA server may store the SM ID, the operator ID, and the OTP data, received from the MSO server, in association with each other.

According to an aspect of the present invention, there is provided an MSO server, including: a database to store an SM ID, an operator ID, and OTP data in association with each other; an authentication processing unit to authenticate a subscription of a DCAS host requesting the subscription by referring to a database; and a updated information communication unit to report the subscription of the authorized DCAS host to another MSO server using an SM ID and OTP data of the authorized DCAS host.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of a Downloadable Conditional Access System (DCAS) according to an embodiment of the present invention;

FIG. 2 is a diagram illustrating an example of an operation where a Conditional Access (CA) server manages an operator identifier (ID) and a Secure Micro (SM) ID and detects a duplicated SM in a DCAS according to an embodiment of the present invention;

FIG. 3 is a diagram illustrating an example where a Trusted Authority (TA) server manages an operator ID and an SM ID and detects a duplicated SM in a DCAS according to another embodiment of the present invention; and

FIG. 4 is a block diagram illustrating a configuration of a Multiple System Operator (MSO) server according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

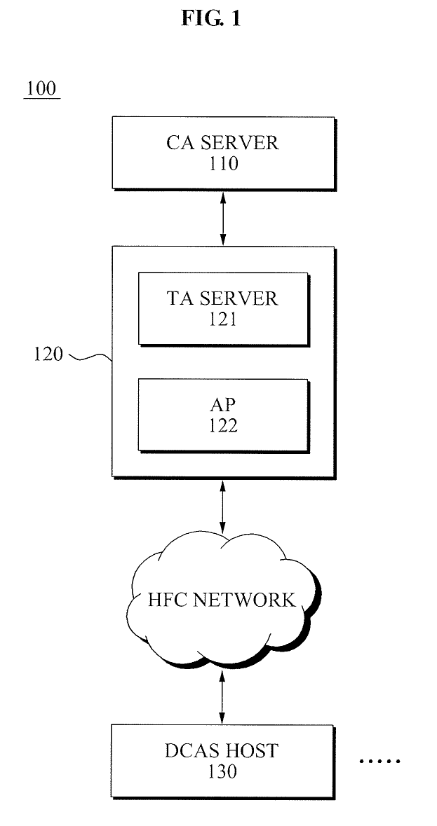

FIG. 1 is a block diagram illustrating a configuration of a Downloadable Conditional Access System (DCAS) 100 according to an embodiment of the present invention.

Referring to FIG. 1, the DCAS 100 may include a Conditional Access (CA) server 110 and a Multiple System Operator (MSO) server 120.

The CA server 110 may a Secure Micro (SM) certificate to all Trusted Authority (TA) servers 121 in an Authentication Proxy (AP) zone every time an SM certificate is newly generated. Accordingly, all the TA servers 121 in the AP zone may manage a latest SM certificate all the time.

In the present specification, the AP zone may indicate a coverage area where a particular MSO provides a cable broadcasting service. That is, the AP zone may be classified by an MSO, and an AP identifier (ID) of each AP zone may be an operator ID of an MSO.

The MSO 120 may further include an AP 122 as well as the TA server 121. The TA server 121 may be independent of the MSO server 120, and authenticate an SM and Transport Processor (TP).

The AP 122 and the TA server 121 may be located in the MSO server 120, and the AP 122 may function as a proxy of the TA.

The MSO server 120 may further include a Personalization Server (PS) to manage an image of application programs. The image may be transmitted to a subscriber host.

Since the CA server 110 transmits the latest SM certificate every time the SM certificate is newly generated, the TA server 121 of the MSO server 120 may store an updated SM ID.

A DCAS host 130 may perform communication with the AP 122 of the MSO server 120 through a Hybrid Fiber Coaxial (HFC) network, and include an SM, which is a security chip, and a TP which is a descrambler chip. According to an embodiment of the present invention, the DCAS host 130 may indicate a set top box.

When a subscription application is received from the DCAS host 130, the MSO server 120 may transmit a registration request for the SM ID, the operator ID, and One Time Password (OTP) data of the DCAS host 130 to the CA server 110.

The SM ID of the SM certificate and N pieces of OTP data may be included in the subscription application. A TA server which receives a certificate, including an SM ID from the CA server 110, in each AP zone may extract the SM ID, and may manage a database for another SM ID.

Accordingly, the CA server 110 may store the SM ID, the operator ID, and the OTP data, received from the MSO server 120, in association with each other.

The TA server 121 may perform initialization with respect to the SM and the TP as well as the authentication of the SM and the TP. Also, the SM may store and operate a Conditional Access (CA) application, a Digital Right Management (DRM) application, and an Authorized Service Domain (ASD) application, and maintain and manage information about various fee-based viewing entitlements.

The MSO server 120 may receive all generated SM certificates from the CA server 110. Specifically, when a first generated SM certificate is received from the CA server 110, the MSO server 120 may extract and store an SM ID from the SM certificate. When the subscription application is received from the DCAS host 130, and the SM ID, transmitted by the DCAS host 130 according to the subscription application, is not previously stored, the MSO server 120 may determine that the SM certificate is not appropriately generated, and disregard the subscription application.

In a DCAS in a conventional art, a TA server may be independently located outside an MSO server, and detect a duplicated SM of a DCAS host. In the DCAS 100 according to an embodiment of the present invention, however, the TA server 121 may be located in the MSO server 120, and efficiently detect a duplicated SM.

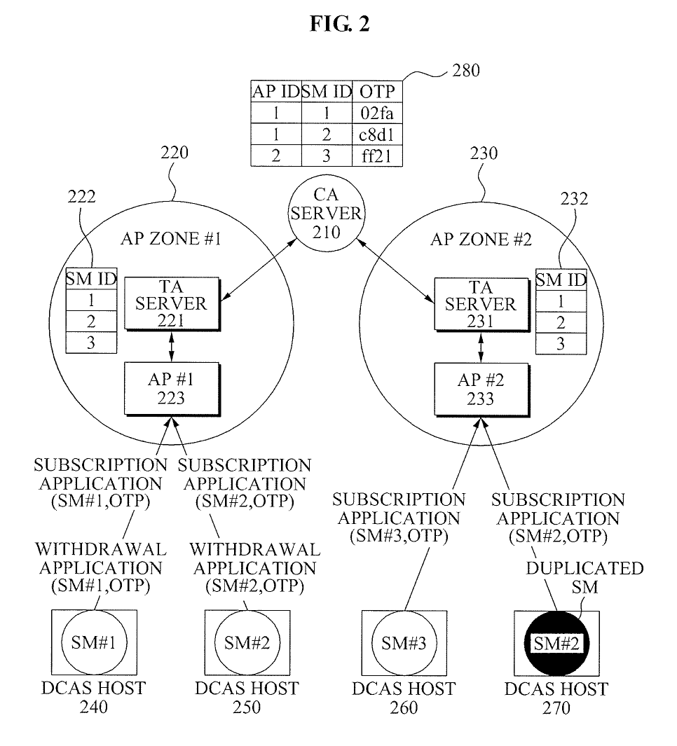

FIG. 2 is a diagram illustrating an example of an operation where a CA server manages an operator ID and an SM ID and detects a duplicated SM in a DCAS according to an embodiment of the present invention.

Referring to FIG. 2, a pair of AP servers and a pair of SMs of each of the pair of AP servers are controlled by a CA server 210.

As described above with reference to FIG. 1, the CA server 210 may transmit a newly generated SM certificate to TA servers in all AP zones, every time an SM certificate is generated.

Accordingly, the TA servers of each of the AP zones may maintain a latest SM certificate all the time. As illustrated in FIG. 2, the TA server 221 of the AP zone #1 220 may maintain a table 222 including an SM ID every time an SM certificate is generated. The SM ID may be received from the CA server 210. Similar to the TA server 221, the TA server 231 of the AP zone #2 230 may maintain a table 232 including an SM ID every time an SM certificate is generated. The SM ID may be received from the CA server 210.

The SM certificate may include the SM ID and N pieces of OTP data. The TA servers 221 and 231 of each of the AP zones 220 and 230 may receive the SM certificate including the SM ID from the CA server 210, extract the SM ID, generate a separate database, and store and manage a table.

Specifically, a DCAS host 240 including a security chip SM #1 may transmit a subscription application to the AP zone #1 220.

The DCAS host 240 may transmit its SM ID, that is, SM #1, and OTP data to the AP zone #1 220 according to the subscription application.

Here, the OTP data may be based on an S/Key scheme (RFC1760). Accordingly, when an SM is initially subscribed to an AP, the OTP data may be obtained by hashing a secret value (for example, a private key) of an SM n−1 times. That is, the SM may be initially subscribed to the AP using the OTP data obtained by hashing the secret value of the SM one more time compared to a reference value.

The S/Key scheme may be a system to prevent an attack by sniffing a packet when signed in a remote system through a public network. A password may change every time in the S/Key scheme.

Since the S/Key scheme may use a hash function, which is an encryption algorithm, confidential information does not remain in a host. That is, the S/Key scheme may be simple and secure.

A Message Digest 4 (MD4), MD5, or Secure Hash Algorithm 1 (SHA1) may be used as the hash function. An input value may not be ascertained due to an irreversibility of the hash function, even when a hash value is already known. Also, a new input value having a same hash value may not be ascertained.

The TA server 221 of the AP zone #1 220 may confirm whether the SM #1 exists in the table 222. When the SM #1 does not exist in the table 222, the TA server 221 may disregard the subscription application of the DCAS host 240.

Conversely, when the SM#1 exists in the table 222, the TA server 221 may transmit an AP #1, that is, an AP ID, the SM #1, and OTP data of the SM #1, to the CA server 210.

The CA server 210 may confirm whether a same value exists in an AP ID/SM ID/OTP management table using the AP ID and the SM ID transmitted by the TA server 221. In this instance, after the OTP data transmitted by the TA server 221 is hashed one time, the CA server 210 may confirm whether the hashed OTP data is identical to the OTP data, previously stored in the CA server 210, of the SM #1, based on the S/Key scheme (RFC1760).

When the same AP ID and SM ID do not exist, and authentication of the OTP data is successful, a message that the SM #1 is valid may be transmitted to the TA server 221.

The CA server 210 may manage the AP ID and the SM ID, transmitted by the TA server 221, and the updated OTP data in an OTP table 280 of a database.

A DCAS host 250 including an SM #2 may transmit a subscription application to the AP zone #1 220. In this instance, the subscription application may be processed in a same manner as described above.

According to an embodiment of the present invention, a DCAS host 260 including an SM #3 may transmit a subscription application to the AP zone #2 230. In this instance, the subscription application may be processed in the same manner as described above.

A DCAS host 270 including a duplicated SM #2 may transmit a subscription application to the AP zone #2 230. In this instance, since the SM #2 is the duplicate of the SM #2 subscribed to the AP zone #1 220, the duplicated SM #2 may have a same SM ID and a same OTP data.

The TA server 231 of the AP zone #2 230 may confirm whether the same SM ID exists in a table 232.

In this instance, since the SM #2 is a duplicate, the SM ID may exist in the table 232 of the SM ID.

Accordingly, the TA server 231 may transmit an AP ID, the SM ID, and the OTP data to the CA server 210.

The CA server 210 may search the OTP table 280 of the database with respect to the AP ID, the SM ID, and the OTP data, using the AP ID and the SM ID transmitted by the TA server 231.

When the same SM ID exists, the CA server 210 may transmit a message that the SM ID is invalid to the TA server 231.

In this case, since the SM #1 is registered in the AP zone #1, the same SM ID may exist in the OTP table 280 of the database with respect to the AP ID, the SM ID, and the OTP data.

Accordingly, the CA server 210 may transmit a message where the SM #2 is invalid to the TA server 231 of the AP zone #2 230.

The DCAS according to an embodiment of the present invention may transmit a withdrawal application to the TA server 221, when the SM #1 desires to withdraw to move to an AP zone provided by another MSO server.

In this instance, the OTP data transmitted by the TA server 221 to the CA server 210 has already been processed with respect to the subscription application, the OTP data may be obtained by hashing a secret value such as a private key of the SM n−2 times based on the S/Key scheme (RFC1760). That is, the SM may request the AP #1 223 for the withdrawal application using the secret value hashed two times more compared to the reference value.

In the S/Key scheme according to an embodiment of the present invention, a hash function may be applied to an input value a predetermined number of times ‘n’, n passwords for one-time use may be generated, and a password which is finally generated may be used for an authentication server and a user (or a user software).

When the user attempts a user authentication using an n−1^{th} password of previously generated passwords, the authentication server may determine whether a value is equal to an n^{th} password stored in the authentication server, and thereby may determine a success or failure of the authentication. Here, the value may be obtained by hashing a password received from the user once. Also, when the authentication is successful, the authentication server may store the n−1^{th} password as a new password, and then use a value, obtained by hashing one less time compared to the reference value, as a password.

The TA server 221 may determine that the SM ID is valid through the table 222, and transmit the AP ID, the SM ID, and the OTP data to the CA server 210.

The CA server 210 may confirm whether the AP ID and the SM ID, included in the withdrawal application message received from the TA server 221, exist in the OTP table 280 of the database managed by the CA server 210.

When the AP ID and the SM ID exist, the CA server 210 may verify the OTP data. For the verification of the OTP data, it is required to determine whether a value, obtained by hashing with respect to the OTP data received from the TA server 221 once, is equal to a value included in the OTP table 280, that is, a value hashed n−1 times.

After the verification of the OTP data, the CA server 210 may store a value, hashed n−2 times, in the OTP table 280 based on the S/Key scheme (RFC1760). Only when the AP ID, the SM ID, and the OTP data is successfully verified, may the withdrawal application be processed.

When the DCAS host 270 of the duplicated SM #2 transmits a subscription application to the AP zone #2 230 after the DCAS host 250 of the SM #2 in the AP zone #1 220 withdraws, the duplicated SM #2 may transmit the same information as the SM #2 of the AP zone #1 220 to the TA server 231 of the AP zone #2 230. In this instance, when the SM #2 is duplicated before withdrawal, the OTP data may be a value obtained by hashing a secret value of the SM n−1 times. When the SM #2 is duplicated after withdrawal, the OTP data may be a value obtained by hashing a secret value of the SM n−2 times.

The TA server 231 of the AP zone #2 230 may ascertain whether a corresponding SM ID exists in a management table 232 of the SM ID. When the SM ID exists, the TA server 231 may transmit an AP ID, the SM ID, and OTP data to the CA server 210.

The CA server 210 may verify validity of the DCAS host 270 of the SM #2 where the subscription application is requested, using the AP ID, the SM ID, and the OTP data received from the TA server 231.

In this instance, the CA server 210 may confirm whether a same AP ID, SM ID, and OTP data exist in the AP ID/SM ID/OTP management table 280.

When the same AP ID, SM ID, and OTP data do not exist, the CA server 210 may confirm whether a value, obtained by hashing the OTP data received from the TA server 231, is identical to OTP data in the AP ID/SM ID/OTP management table 280.

In this instance, the OTP data transmitted by the SM #2 may be a value hashed n−1 times or n−2 times based on the S/Key scheme (RFC1760). Accordingly, the value may be identical to a value obtained by hashing a secret value of the SM #2 n times or n−1 times.

However, since the OTP data in the AP ID/SM ID/OTP management table 280 corresponds to n−2 as described above, the verification of the OTP data may fail.

Accordingly, the CA server 210 may report to the TA server 231 of the AP zone #2 230 that the subscription of the duplicated SM #2 is not approved.

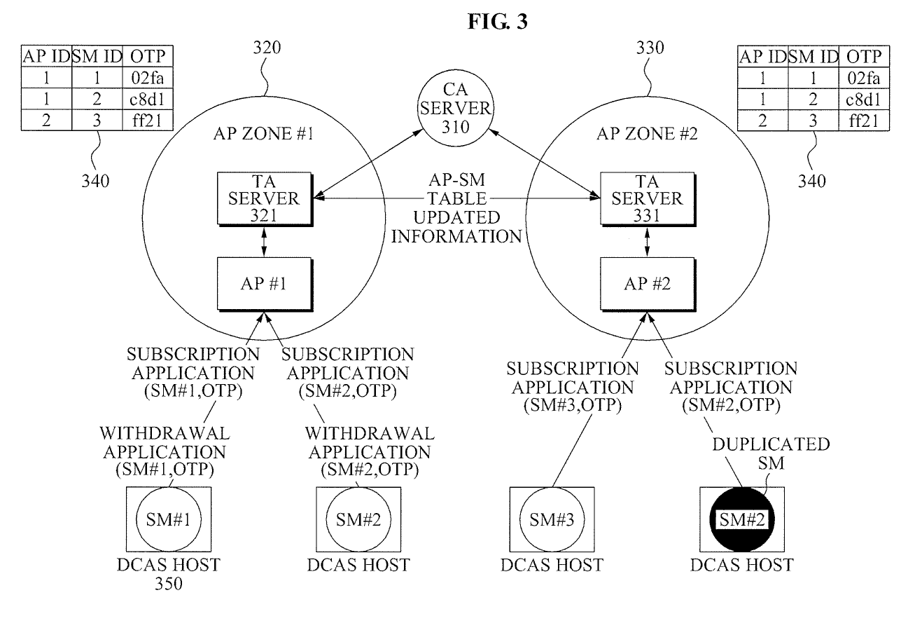

FIG. 3 is a diagram illustrating an example where a TA server manages an operator ID and an SM ID and detects a duplicated SM in a DCAS according to another embodiment of the present invention.

FIG. 3 illustrates an operation where only a TA server in an AP zone manages a pair of AP IDs and a pair of SM IDs of each of the AP IDs without control of a CA server 310.

In FIG. 3, an operation of exchanging updated information of AP-SM tables 340 between a TA server 321 of an AP zone #1 320 and a TA server 331 of an AP zone #2 330 may be added unlike the example of FIG. 2. That is, since an AP ID, an SM ID, and OTP data are not stored in the CA server 310, the updated information is to be shared between the TA server 321 of the AP zone #1 320 and the TA server 331 of the AP zone #2 330.

Also, all operations may be performed in a similar manner to the example of FIG. 2 except that each of the TA servers 321 and 331 as opposed to the CA server 310 manages an AP ID/SM ID/OTP management table.

For example, when a DCAS host 350 of an SM #1 of the AP zone #1 320 transmits a subscription application, the TA server 321 of the AP zone #1 320 may receive the subscription application, and confirm whether a same SM ID exists in the AP ID/SM ID/OTP management table.

When the same SM ID does not exist, the TA server 321 may approve the subscription application of the DCAS host 350, and simultaneously transmit a value and the AP ID of the TA server 321 itself to all TA servers of other AP zones. Here, the value may be obtained by hashing the OTP data and the SM ID received when the subscription application of the SM #1 is received.

When the updated information of the AP-SM tables 340 is received, all the TA servers of other AP zones may update an AP ID/SM ID/OTP management table of each of the TA servers based on the received updated information.

In a DCAS in a conventional art, a TA server may be independently located outside of an MSO server, and detect a duplicated SM ID of a DCAS host. However, in the DCAS according to another embodiment of the present invention, a TA server may be located in an MSO server, and efficiently detect a duplicated SM.

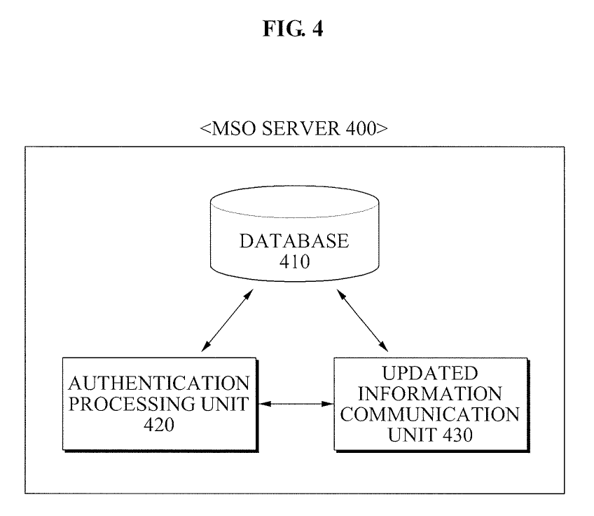

FIG. 4 is a block diagram illustrating a configuration of an MSO server 400 according to an embodiment of the present invention.

The MSO server 400 may include a database 410, an authentication processing unit 420, and an updated information communication unit 430.

The database 410 may store an SM ID, an operator ID, and OTP data in association with each other. When a first SM certificate of a DCAS host is issued, the database 410 may receive and store the SM ID, an operator ID, and OTP data from a CA server or a TA server of another MSO server.

The authentication processing unit 420 may authenticate a subscription of a DCAS host requesting the subscription by referring to the database 410. The updated information communication unit 430 may report the subscription of the authorized DCAS host to another MSO server using an SM ID and OTP data of the authorized DCAS host.

According to the present invention, the MSO server 400 may manage to which MSO an SM ID of a DCAS host is subscribed, without a CA server, and thereby may prevent the SM ID from being used for duplication.

Also, according to the present invention, the updated information communication unit 430 may transmit OTP data, which is obtained by hashing the SM ID, the operator ID, and the OTP data once, to the other MSO, and thereby may report the subscription of the DCAS host.

Also, according to the present invention, a duplicated SM may be efficiently detected by dispersively arranging TAs.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A Downloadable Conditional Access System (DCAS), comprising:
a Conditional Access (CA) server; and
a Multiple System Operator (MSO) server to store a Secure Micro (SM) identifier (ID), and when a subscription application is received from a DCAS host, to transmit a registration request for the SM ID, an operator ID, and One Time Password (OTP) data of the DCAS host to the CA server,
wherein the CA server stores the SM ID, the operator ID, and the OTP data, received from the MSO server, in association with each other.

2. The DCAS of claim 1, wherein the MSO server comprises a Trusted Authority (TA) server to authenticate an SM and a Transport Processor (TP) of the DCAS host.

3. The DCAS of claim 1, wherein the CA server transmits an initially issued SM certificate to the MSO server, and the MSO server extracts and stores an SM ID from the received SM certificate.

4. The DCAS of claim 1, wherein the OTP data, received by the MSO server when the subscription application is received from the DCAS host, is based on an S/Key scheme, and the OTP data is obtained by hashing a secret value of an SM one more time compared to a reference value, when the DCAS host is initially subscribed to the MSO server.

5. The DCAS of claim 4, wherein, when a withdrawal application is received from the DCAS host, the MSO server hashes the secret value of the SM two times more compared to the reference value, and transmits the hashed secret value to the CA server for the withdrawal application.

6. The DCAS of claim 5, wherein the MSO server transmits the operator ID and the SM ID to the CA server when the withdrawal application is received, and
the CA server confirms whether the operator ID and the SM ID exist in a database in response to the withdrawal application, verifies the OTP data, and processes the withdrawal application when the operator ID and the SM ID exist in the database.

7. The DCAS of claim 1, wherein, when the registration request of the DCAS host is received from the MSO server, the CA server identifies the SM ID and operator ID where the registration is requested, determines whether the SM ID and operator ID are identical to a previously stored SM ID and operator ID, and determines that the DCAS host is invalid when the SM ID and operator ID are identical to the stored SM ID and operator ID.

8. An MSO server, comprising:
a database to store an SM ID, an operator ID, and OTP data in association with each other;
an authentication processing unit to authenticate a subscription of a DCAS host requesting the subscription by referring to a database; and
a updated information communication unit to report the subscription of the authorized DCAS host to another MSO server using an SM ID and OTP data of the authorized DCAS host.

9. The MSO server of claim 8, wherein the updated information communication unit transmits OTP data to the other MSO server to report the subscription of the DCAS host to the other MSO server, the OTP data being obtained by hashing the SM ID, the operator ID, and the OTP data once.
